(19) United States
(12) Patent Application Publication
(10) Pub. No.: US 2015/0176458 A1
(43) Pub. Date: Jun. 25, 2015

(54) METHOD AND SYSTEM FOR PURIFYING NOx IN INTERNAL COMBUSTION ENGINE

(71) Applicant: HYUNDAI MOTOR COMPANY, Seoul (KR)

(72) Inventor: Jun-Sung Park, Yongin-si (KR)

(21) Appl. No.: 14/559,883

(22) Filed: Dec. 3, 2014

(30) Foreign Application Priority Data
Dec. 20, 2013 (KR) 10-2013-0160107

(51) Int. Cl. F01N 3/20; F02D 41/02

(52) U.S. Cl. CPC F01N 3/208; F02D 41/0275

(57) ABSTRACT

In a method for purifying NO_{X} in an internal combustion engine, a catalyst of a nitrogen oxide purification device is regenerated by control of an air-fuel ratio (lean→rich) through one or more control of an engine fuel injection device (10-1), a throttle valve (10-2), and an EGR valve (10-3) in an intermediate/high-load operating condition. On the other hand, a nitrogen oxide purification catalyst is regenerated through a chemical reaction between nitrogen oxides and hydrocarbon generated during the injection of fuel in a secondary fuel injection device in a low-load operating condition. Consequently, the catalyst may be regenerated in the entire operating region of an engine.

### CROSS-REFERENCE(S) TO RELATED APPLICATIONS

This application claims priority to Korean Patent Application No. 10-2013-0160107, filed on Dec. 20, 2013, which is incorporated herein by reference in its entirety.

### BACKGROUND

1. Technical Field

Exemplary embodiments of the present invention relate to an internal combustion engine; and, particularly, to a method of and system for purifying NO_{X} in an internal combustion engine in which an individual nitrogen oxide purification process is applied in different manners according to operating conditions of an engine or vehicle so that nitrogen oxides may be efficiently purified in the entire operating region of the engine without performance degradation of the engine.

2. Description of Related Art

In general, nitrogen oxides (NO_{X}) are contained in exhaust gas generated during operation of an internal combustion engine, and thus a strengthened emission regulations require more nitrogen oxides to be removed.

For this reason, a nitrogen oxide purification device as an after-treatment device is necessarily applied to a vehicle. The nitrogen oxide purification device removes nitrogen oxides by adsorption or occlusion of the nitrogen oxides in a nitrogen oxide purification catalyst.

The nitrogen oxide purification device is installed at a rear end of an exhaust manifold of the internal combustion engine.

In addition, the nitrogen oxide purification device should be regenerated for purification of the adsorbed or occluded nitrogen oxides.

Accordingly, when it is determined that the nitrogen oxide purification device needs to be regenerated, the nitrogen oxide purification device is regenerated in such a way as to adjust a fuel injection device or air control device in an engine combustion chamber so as to control air-fuel ratio and to form a rich condition under a normal operating condition by air-fuel ratio control.

However, control of the air-fuel ratio during regeneration of the nitrogen oxide purification device may bring about a large engine torque variation. For this reason, rich operation is limited.

Thus, it is difficult to easily purify nitrogen oxides. An example of an operating limitation may include driving for a commuting time or in a downtown region. This is because it is almost impossible to control air-fuel ratio using the fuel injection device or air control device in the engine combustion chamber and to purify nitrogen oxides therethrough since most operating conditions are under a low-speed and low-load condition. Thus, nitrogen oxide occlusion performance in the nitrogen oxide purification device including a nitrogen oxide occlusion catalyst will gradually deteriorate and consequently the nitrogen oxide purification device may not exhibit normal purification performance for nitrogen oxides.

In particular, since control of the air-fuel ratio during regeneration of the nitrogen oxide purification device may bring about a large engine torque variation, there is a need to minimize the torque variation during air-fuel ratio control.

### SUMMARY

An embodiment of the present invention is directed to a method and system for purifying NO_{X} in an internal combustion engine in which a nitrogen oxide purification catalyst is regenerated by control of an air-fuel ratio of an engine from a lean state to a rich state in an intermediate/high-load operating condition, whereas the nitrogen oxide purification catalyst is regenerated through a chemical reaction between nitrogen oxides and hydrocarbon generated during injection of fuel from a secondary fuel injection device in a low-load operating condition, so that the catalyst is capable of being regenerated in the entire operating region of the engine. Particularly, in the method and system for purifying NO_{X} in an internal combustion engine, since torque variation is not generated when the catalyst is regenerated in the low-load operating condition, an operating limitation such as driving for a commuting time or in a downtown region is resolved and thus strengthened emission regulations may be satisfied.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method of purifying NO_{X} in an internal combustion engine includes dividing operating conditions into an intermediate/high-load operating condition and a low-load operating condition in an internal combustion engine before regeneration of a nitrogen oxide purification catalyst is performed, performing unconstrained condition catalyst regeneration in which, when the regeneration is performed in the intermediate/high-load operating condition, an air-fuel ratio of the engine is changed from a lean state to a rich state and the catalyst is regenerated by exhaust gas having a rich air-fuel ratio, and performing constraint condition catalyst regeneration in which, when the regeneration is performed in the low-load operating condition, an air-fuel ratio of exhaust gas discharged from the engine is alternated through injection of fuel from a secondary fuel injection device and the catalyst is regenerated through a chemical reaction between nitrogen oxides and hydrocarbon.

Regeneration of the nitrogen oxide purification catalyst may be performed within a range of 10 to 80% of a maximum adsorption/occlusion amount of nitrogen oxides in the nitrogen oxide purification catalyst.

In performing unconstrained condition catalyst regeneration, the air-fuel ratio of the engine may be changed from the lean state to the rich state using one or more of an engine fuel injection device, a throttle valve, and an EGR valve.

In performing constraint condition catalyst regeneration, the fuel may be injected to exhaust gas by a secondary fuel injection device.

The second fuel injection may be performed at a front end of a nitrogen oxide purification device.

The front end of the nitrogen oxide purification device may be a rear end of an exhaust manifold of the engine or a rear end of a turbocharger.

The method may further include performing an unconstrained condition check, in which a time at which the air-fuel ratio of the engine is changeable is determined before the regeneration is performed under the intermediate/high-load operating condition when performing unconstrained condition catalyst regeneration, and the intermediate/high-load operating condition is changed to the low-load operating condition when it is determined that the time at which the air-fuel ratio is changeable is not suitable for the regeneration.

The time at which the air-fuel ratio is changeable may be one operation time of an engine fuel injection device, a throttle valve, and an EGR valve.

In accordance with another embodiment of the present invention, a system for purifying NO_{X} in an internal combustion engine includes an internal combustion engine including a turbocharger for compressing air supplied to an intake manifold, an EGR (Exhaust Gas Recirculation) for transferring exhaust gas to the intake manifold using exhaust gas discharged from an exhaust manifold, and a nitrogen oxide purification device installed on an exhaust line to remove nitrogen oxides by adsorbing or occluding the nitrogen oxides, a rich air-fuel ratio changing device for changing an air-fuel ratio of the engine to a rich condition so that exhaust gas having a rich air-fuel ratio condition is generated, and a secondary fuel injection device for alternating an air-fuel ratio of exhaust gas such that nitrogen oxide purification through a chemical reaction between nitrogen oxides and hydrocarbon is performed in the nitrogen oxide purification device.

The rich air-fuel ratio changing device may include an engine fuel injection device, a throttle valve, and an EGR valve. The secondary fuel injection device may inject fuel through control of operation frequency and duty.

The secondary fuel injection device may be installed at a rear end of the exhaust manifold, at a rear end of the turbocharger or at a front end of the nitrogen oxide purification device.

### BRIEF DESCRIPTION OF THE DRAWINGS

FIGS. 1A and B is an operation flowchart for purification of nitrogen oxides in an internal combustion engine according to an embodiment of the present invention.

FIG. 2 is a view illustrating a configuration of a nitrogen oxide purification system of the internal combustion engine according to the embodiment of the present invention.

FIG. 3 is a view illustrating a modified configuration of the nitrogen oxide purification system of the internal combustion engine according to the embodiment of the present invention.

FIG. 4 is a graph illustrating nitrogen oxide purification with respect to secondary fuel injection in the nitrogen oxide purification system of the internal combustion engine according to the embodiment of the present invention.

FIG. 5 is a view illustrating a state in which the nitrogen oxide purification in the internal combustion engine is performed under an intermediate/high-load operating condition according to the embodiment of the present invention.

FIG. 6 is a view illustrating a state in which the nitrogen oxide purification in the internal combustion engine is performed under a low-load operating condition according to the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

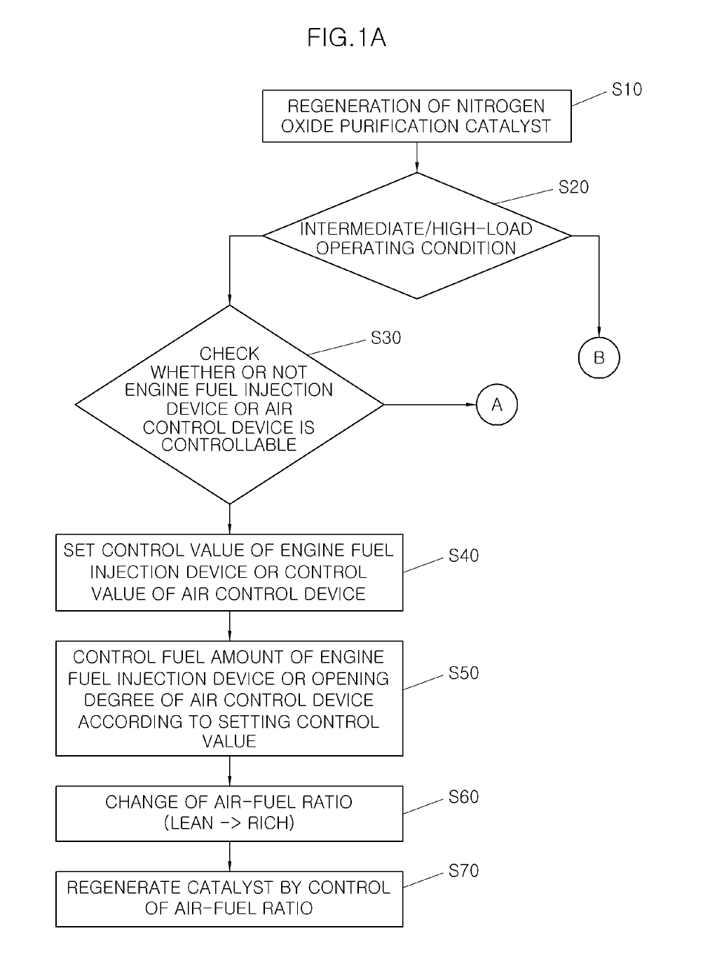

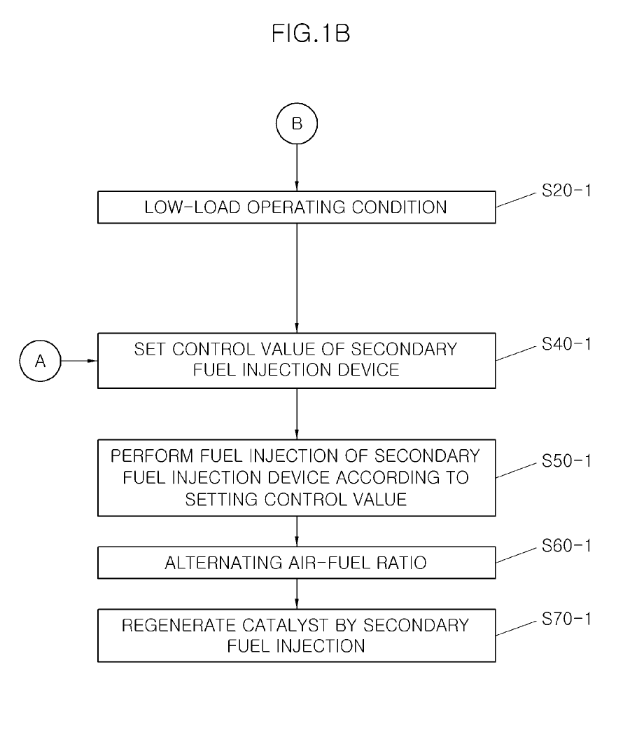

FIGS. 1A and B are an operation flowchart for purification of nitrogen oxides in an internal combustion engine according to an embodiment of the present invention.

Step S10 refers to regeneration of a nitrogen oxide purification catalyst. A condition in which the regeneration of the nitrogen oxide purification catalyst is performed within a range of 10 to 80% of a maximum adsorption/occlusion amount of nitrogen oxides in the nitrogen oxide purification catalyst is applied.

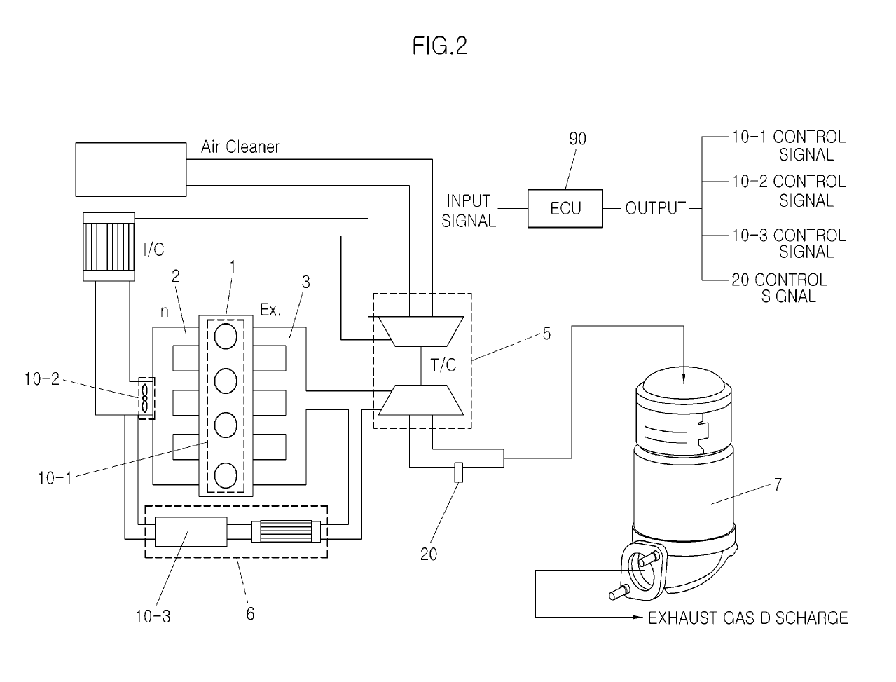

In the embodiment, the nitrogen oxide purification catalyst may be an LNT (Lean NO_{X} Trap) catalyst and is provided in a nitrogen oxide purification device installed on an exhaust line. A nitrogen oxide purification system for the same is provided in a lean-burn engine. FIG. 2 illustrates a configuration of the nitrogen oxide purification system.

As shown in the drawing, the engine 1 includes a turbocharger 5 which compresses air supplied to an intake manifold 2, an EGR (Exhaust Gas Recirculation) 6 which transfers exhaust gas to the intake manifold 2 using exhaust gas discharged from an exhaust manifold 3, a nitrogen oxide purification device 7 which is installed on the exhaust line and has an LNT (Lean NO_{X} Trap) catalyst removing nitrogen oxides by adsorbing or occluding the nitrogen oxides, and a nitrogen oxide purification system in which an individual catalyst regeneration process is applied in different manners in an intermediate/high-load operating condition and a low-load operating condition so that the nitrogen oxide purification catalyst is regenerated in a the entire operating region of the engine.

The nitrogen oxide purification system includes a rich air-fuel ratio changing device 10-1, 10-2, 10-3 in which the catalyst is regenerated in the intermediate/high-load operating condition, and a secondary fuel injection device 20 in which the catalyst is regenerated in the low-load operating condition.

The rich air-fuel ratio changing device 10-1, 10-2, 10-3 is a device which changes an air-fuel ratio from a lean-burn state to a rich-burn state to purify nitrogen oxides. To that end, the rich air-fuel ratio changing device 10-1, 10-2, 10-3 includes an engine fuel injection device 10-1 installed in a combustion chamber of the engine 1, a throttle valve 10-2 installed on an intake passage connected to the intake manifold 2, and an EGR valve 10-3 installed on an EGR line.

The engine fuel injection device 10-1 injects fuel into the combustion chamber of the engine 1.

The throttle valve 10-2 regulates flow rate of air supplied to the combustion chamber of the engine 1 by controlling degree of opening of the throttle valve.

The EGR valve 10-3 regulates flow rate of EGR gas supplied to the combustion chamber of the engine 1 by controlling degree of opening of the EGR valve.

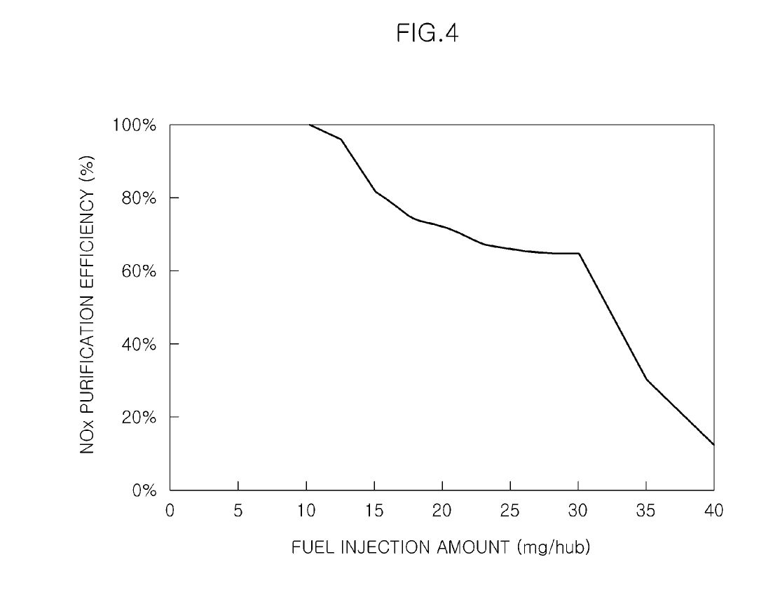

On the other hand, the secondary fuel injection device 20 is a device which purifies nitrogen oxides through a chemical reaction between nitrogen oxides and hydrocarbon generated during injection of fuel. The injection is performed through control of operation frequency and control of duty (0 to 100%), and an air-fuel ratio of exhaust gas discharged from the engine is alternated through injection of fuel from a secondary fuel injection device. In this case, a fuel injection amount is illustrated in an NO_{X}-fuel injection amount graph of FIG. 4.

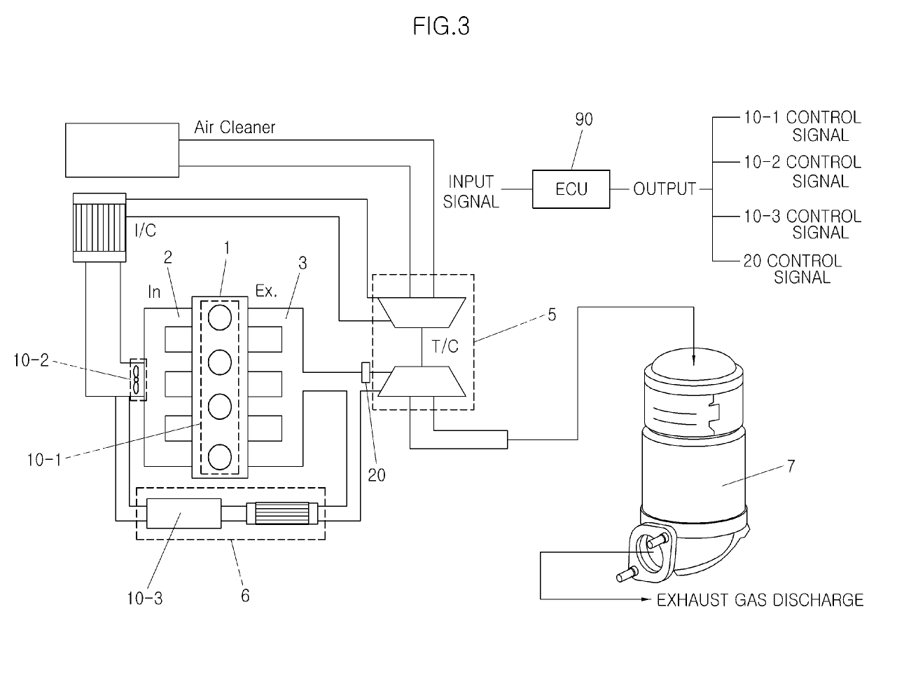

Generally, the secondary fuel injection device 20 is installed at a front end of the nitrogen oxide purification catalyst 7 so that the injection of fuel is performed in the front of the nitrogen oxide purification catalyst 7. However, the installation position of the secondary fuel injection device 20 may be changed as shown in FIG. 3. As shown in FIG. 3, the secondary fuel injection device 20 may be installed at a rear end of exhaust manifold 3 to be located in the front of the turbocharger 5. In this case, an engine fuel injection device 10-1, a throttle valve 10-2, and an EGR valve 10-3 are installed at the same positions as those of FIG. 2. Therefore, the secondary fuel injection device 20 is configured such that the injection of fuel is performed in the rear of the exhaust manifold 3.

Referring again to FIGS. 1A and B, regeneration of the nitrogen oxide purification catalyst at step S10 is performed in divided conditions such as the intermediate/high-load operating condition at step S20 and the low-load operating condition at step S20-1.

In regeneration of the nitrogen oxide purification catalyst to which the intermediate/high-load operating condition at step S20 is applied, a large torque variation may not be generated when the air-fuel ratio is changed to a rich condition. In the regeneration of the nitrogen oxide purification catalyst to which the low-load operating condition at step S20-1 is applied, a large torque variation may be generated when the air-fuel ratio is changed to the rich condition.

When regeneration of the nitrogen oxide purification catalyst to which the intermediate/high-load operating condition at step S20 is applied is performed, it is checked whether or not the engine fuel injection device or the air control device is controllable as at step S30. This example may include a case in which the air-fuel ratio is not controllable for a long time through control of the engine fuel injection device or air control device in the combustion chamber, or a case in which adsorption or occlusion of nitrogen oxides in the nitrogen oxide purification catalyst is under a preset level or more but the air-fuel ratio is not controllable through control of the engine fuel injection device or air control device in the combustion chamber.

Here, the preset level is defined as a preset time required such that an amount of adsorption or occlusion of nitrogen oxides in the nitrogen oxide purification catalyst is typically filled within a range of 10 to 80% of a maximum adsorption/occlusion amount of nitrogen oxides. However, the preset time may be differently set according to the types of nitrogen oxide purification catalysts and methods of nitrogen oxide purification. Therefore, when the engine fuel injection device or the air control device is not controllable as the checked result at step S30, the operation is advanced to step S40-1 and thus the secondary fuel injection device may be operated even in the intermediate/high-load operating condition.

On the other hand, when the engine fuel injection device or the air control device is controllable as the checked result at step S30, a control value of the engine fuel injection device or a control value of the air control device is set at step S40. Next, a fuel amount of the engine fuel injection device or an openness of the air control device is controlled according to a setting control value at step S50. As a result, the air-fuel ratio is changed (from the lean state to the rich state) as at step S60. Accordingly, the nitrogen oxide purification catalyst is regenerated by control of the air-fuel ratio as at step S70.

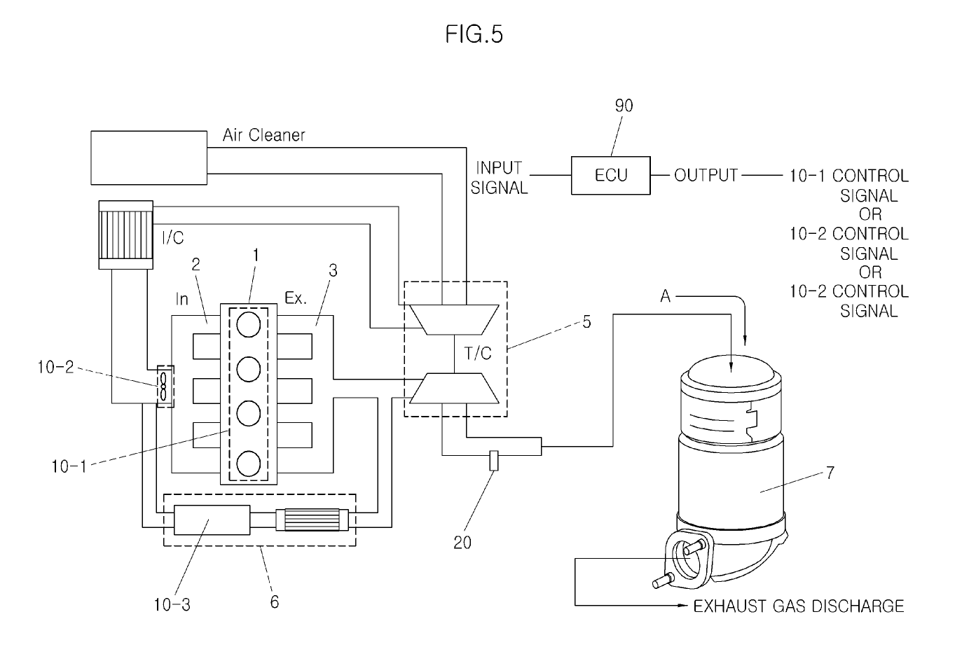

FIG. 5 illustrates the regeneration of nitrogen oxide purification catalyst performed in the intermediate/high-load operating condition. As shown in the drawing, a fuel injection amount of the engine fuel injection device 10-1, an opening degree of the throttle valve 10-2, or an opening degree of the EGR valve 10-3 is changed by control of an ECU (Engine Control Unit) 9 in the intermediate/high-load operating condition. Consequently, the engine 1 is changed from the lean-burn state to the rich-burn state. Thereby, rich exhaust gas is introduced into the nitrogen oxide purification device 7 installed on the exhaust line (see “A” of FIG. 5), so that the catalyst is regenerated. In this case, the secondary fuel injection device 20 is maintained in a stationary state.

Meanwhile, a control value of the secondary fuel injection device is set at step S40-1 in the low-load operating condition at step S20-1. Next, a fuel amount of the secondary fuel injection device is controlled according to a setting control value at step S50-1. As a result, alternating an air-fuel ratio through the injection of fuel is performed as at step S60-1. Consequently, the catalyst of the nitrogen oxide purification device is regenerated through chemical reaction between nitrogen oxides and hydrocarbon generated during the injection of fuel as at step S70.

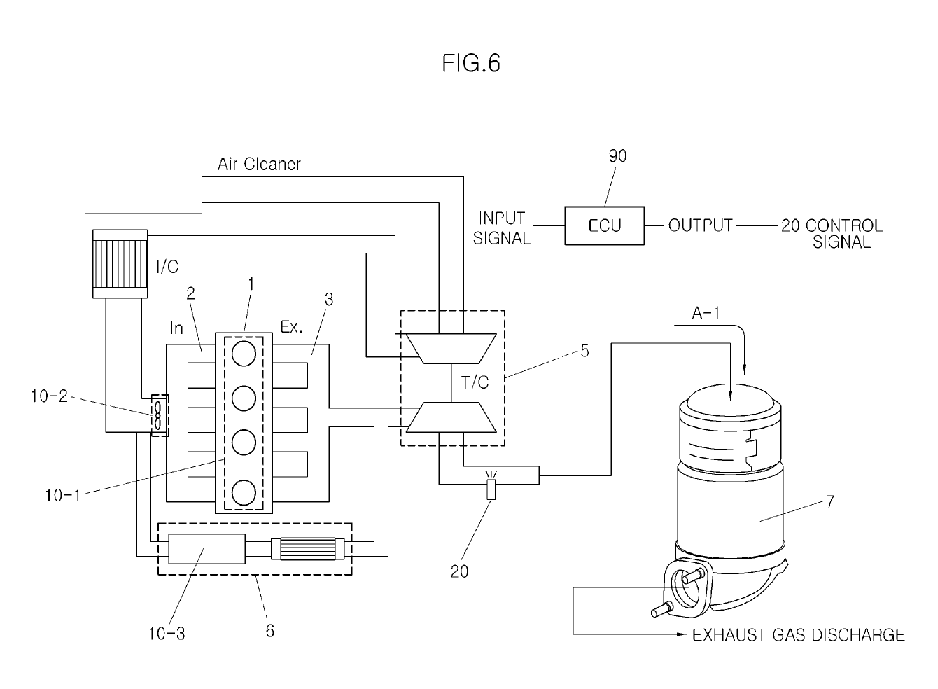

FIG. 6 illustrates regeneration of nitrogen oxide purification catalyst performed through the secondary fuel injection device 20 in the low-load operating condition. As shown in the drawing, the secondary fuel injection device 20 injects fuel by control of the ECU (Engine Control Unit) 9 in the low-load operating condition or a specific intermediate/high-load operating condition, and the engine fuel injection device 10-1, the throttle valve 10-2, and the EGR valve 10-3 may be changed in order to enhance nitrogen oxide purification performance. In this case, the fuel injection of the secondary fuel injection device 20 is performed at a front end of the nitrogen oxide purification device 7 through control of operation frequency (0.1 to 30 Hz) and control of duty (0 to 95%).

As described above, in the method for purifying NO_{X} in the internal combustion engine according to the embodiment, the nitrogen oxide purification catalyst is regenerated by control of the air-fuel ratio (lean state→rich state) through control of one or more of the engine fuel injection device 10-1, the throttle valve 10-2, and the EGR valve 10-3 in the intermediate/high-load operating condition. On the other hand, the nitrogen oxide purification catalyst is regenerated through chemical reaction between nitrogen oxides and hydrocarbon generated during the injection of fuel in the secondary fuel injection device 20 in the low-load operating condition. Consequently, the catalyst may be regenerated in the entire operating region of the engine. Particularly, since torque vibration is not generated when the catalyst of the nitrogen oxide purification device 7 is regenerated in the low-load operating condition, an operating limitation such as driving for a commuting time or in a downtown region is resolved and thus strengthened emission regulations may be satisfied by improved purification performance of nitrogen oxides.

In accordance with the exemplary embodiments of the present invention, a nitrogen oxide purification catalyst is regenerated by a change of an air-fuel ratio of an engine from a lean state to a rich state in an intermediate/high-load operating condition, and the nitrogen oxide purification catalyst is regenerated without control of the air-fuel ratio of the engine in a low-load operating condition. Consequently, discharge of nitrogen oxides may be reduced in the entire load region of the engine.

In addition, since the catalyst is capable of being regenerated in the low-load operating condition without generation of torque vibration as in the intermediate/high-load operating condition, all cases may be resolved in which nitrogen oxides are not purified due to an operating limitation such as driving for a commuting time or in a downtown region.

Furthermore, the individual nitrogen oxide purification catalyst is regenerated in different manners in the intermediate/high-load operating condition and the low-load operating condition so that regeneration of the nitrogen oxide purification catalyst may be enlarged to the entire operating region of the engine. As a result, strengthened exhaust emission regulation may be easily satisfied and particularly it may be possible to improve marketability by comlying to strengthened exhaust emission regulations.

While the present invention has been described with respect to the specific embodiments, it will be apparent to those skilled in the art that various changes and modifications may be made without departing from the spirit and scope of the invention as defined in the following claims.

What is claimed is:

1. A method for purifying NO_{X} in an internal combustion engine, comprising:
dividing operating conditions in an internal combustion engine into an intermediate/high-load operating condition and a low-load operating condition before regeneration of a nitrogen oxide purification catalyst is performed;
performing unconstrained condition catalyst regeneration in which, when the generation is performed in the intermediate/high-load operating condition, an air-fuel ratio of the engine is changed from a lean state to a rich state and the catalyst is regenerated by exhaust gas having a rich air-fuel ratio; and
performing constraint condition catalyst regeneration in which, when the generation is performed in the low-load operating condition, an air-fuel ratio of exhaust gas discharged from the engine is alternated through injection of fuel from a secondary fuel injection device and the catalyst is regenerated through a chemical reaction between nitrogen oxides and hydrocarbon.

2. The method of claim 1, wherein the regeneration of the nitrogen oxide purification catalyst is performed within a range of 10 to 80% of a maximum adsorption/occlusion amount of nitrogen oxides in a nitrogen oxide purification catalyst.

3. The method of claim 1, wherein, in the performing unconstrained condition catalyst regeneration, the air-fuel ratio of the engine is changed from the lean state to the rich state using one or more of an engine fuel injection device, a throttle valve, and an EGR valve.

4. The method of claim 1, wherein, in the performing constraint condition catalyst regeneration, the fuel is injected to exhaust gas by a secondary fuel injection device.

5. The method of claim 1, wherein the secondary fuel injection is performed at a front end of a nitrogen oxide purification device.

6. The method of claim 5, wherein the front end of the nitrogen oxide purification device is a rear end of an exhaust manifold of the engine or a rear end of a turbocharger.

7. The method of claim 1, further comprising performing an unconstrained condition check at a time when the air-fuel ratio of the engine is changeable is determined before the regeneration is performed under the intermediate/high-load operating condition when performing unconstrained condition catalyst regeneration, and the intermediate/high-load operating condition is changed to the low-load operating condition when it is determined that the time at which the air-fuel ratio is changeable is not suitable for the regeneration.

8. The method of claim 7, wherein the time at which the air-fuel ratio is changeable is one operation time of an engine fuel injection device, a throttle valve, and an EGR valve.

9. A system for purifying NO_{X} in an internal combustion engine, comprising:
an internal combustion engine comprising a turbocharger for compressing air supplied to an intake manifold, an EGR (Exhaust Gas Recirculation) for transferring exhaust gas to the intake manifold using exhaust gas discharged from an exhaust manifold, and a nitrogen oxide purification device installed on an exhaust line to remove nitrogen oxides by adsorbing or occluding the nitrogen oxides;
a rich air-fuel ratio changing device for changing an air-fuel ratio of the engine to a rich condition so that exhaust gas having a rich air-fuel ratio condition is generated; and
a secondary fuel injection device for performing an air-fuel ratio exhaust gas such that nitrogen oxide purification through a chemical reaction between nitrogen oxides and hydrocarbon is performed in the nitrogen oxide purification device.

10. The system of claim 9, wherein the rich air-fuel ratio changing device comprises an engine fuel injection device, a throttle valve, and an EGR valve.

11. The system of claim 9, wherein the secondary fuel injection device injects fuel through control of operation frequency and duty.

12. The system of claim 11, wherein the secondary fuel injection device is installed at a rear end of the exhaust manifold, at a rear end of the turbocharger or at a front end of the nitrogen oxide purification device.
